(19) United States
(12) Patent Application Publication
(10) Pub. No.: US 2004/0218985 A1
(43) Pub. Date: Nov. 4, 2004

(54) Method of making a composite masonry block

(76) Inventors: Charles N. Klettenberg, Maple Grove, MN (US); John H. F. Miller, Buffalo, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/447,789

(22) Filed: May 29, 2003

Related U.S. Application Data
(60) Provisional application No. 60/467,122, filed on Apr. 30, 2003.

(51) Int. Cl. B41B 11/54; E02D 3/02; E04C 2/04

(52) U.S. Cl. 405/284; 405/286; 52/596; 52/605; 249/171

(57) ABSTRACT

A concrete mixture may be introduced to a mold. A compression head compresses the concrete mixture in the mold and imparts a decorative front face on the block. The motion of the compression head also urges the mixture into a notched region of the mold cavity to form a protrusion on the block.

### REFERENCE TO RELATED APPLICATIONS

This application claims priority benefit of U.S. Provisional Application No. 60/467,122, filed on Apr. 30, 2003, which is hereby incorporated by reference.

### FIELD OF THE INVENTION

The present invention relates generally to the field of retaining wall blocks. More specifically, the present invention relates to the manufacture of mortarless retaining wall blocks having a protrusion extending from the bottom surface of the block and at least one other surface formed by a compression member of a block making machine.

### BACKGROUND OF THE INVENTION

Retaining walls are used in various landscaping projects and are available in a wide variety of styles. Numerous methods and materials exist for the construction of retaining walls. Such methods include the use of natural stone, poured concrete, precast panels, masonry, and landscape timbers or railroad ties. Composite masonry blocks were developed to allow for high-speed manufacturing, which allowed for a lower manufacturing cost. Composite masonry blocks have become a widely accepted material used for construction of landscaping structures because they are easy to handle and provide substantial uniformity between blocks of a given model.

More recently, retaining walls have been constructed using segmental concrete retaining wall blocks or units that do not require the use of mortar (“mortarless”). Mortarless retaining wall blocks were originally designed to rely upon the weight of the blocks and the configuration of the blocks in a setback fashion to provide structural integrity to the landscape structure. U.S. Pat. No. 2,313,363 provides an example of such a block.

Because many landscape structures such as roadways and bridges do not allow a wall to be constructed in a setback fashion, mortarless blocks were developed that used pins or tiebacks that allowed vertical wall construction. However the early versions of these retaining wall blocks had the disadvantage of being more complex in requiring additional mechanisms for anchoring the structure that make construction difficult. Furthermore, structures constructed of these blocks could become structurally unsound if the anchoring mechanisms failed due to rust or other physical force.

A solution that allowed the use of mortarless blocks to build vertical walls without the use of anchoring mechanisms was the development of blocks having protrusions and insets that interlocked with protrusions and insets of adjacent blocks in a landscape structure. A block of this type is described in U.S. Pat. No. 5,490,363. These blocks provided a mortarless masonry block that could be used to form walls, even entirely vertical walls, of high structural integrity without the use of securing mechanisms. An alternative to the use of protrusions was the addition of a lip located on the bottom rear portion of the block. An example of this type of block is described in U.S. Pat. No. 5,827,015.

An issue that came to light with mortarless masonry blocks was the aesthetics of structures constructed with the blocks. Early blocks were constructed with smooth front surfaces that gave the same appearance as older blocks that were used with mortar in forming walls. An aesthetic improvement to mortarless retaining wall blocks was the addition of decorative front surfaces to the blocks. Originally, these decorative surfaces consisted of striations or grooves. U.S. Pat. No. 4,802,320 provides an example of such a decorative face.

The ability to alter the designs for the front surfaces of retaining wall blocks is limited due to the manufacturing process used in making blocks. High-speed block making machines made by companies such as Besser, Columbia, Fleming, Tiger, KVM, Masa, Zenith, and Omag are now used to mass-produce concrete products. U.S. Pat. No. 5,827,015 describes this manufacturing method.

Conventionally, a block mold with an open top and bottom is mounted in one of these high-speed block making machines and an automated conveyor system moves a pallet, typically a plate of steel, to a position under the mold so that the mold can be filled with some type of curable material. The mold is filled via a feed box that moves horizontally across the mold. The mold is then vibrated to prevent pockets or voids and to obtain a proper fill. The feed drawer is then retracted and a compression member compacts the fill material from the top of the mold. The compression member is then pressed down upon the material from the top of the mold to properly fill the extents of the mold and to provide detail to the block. The member contacting the concrete mixture or mud is conventionally referred to as a stripper shoe. The detail provided to the blocks is most often a lip and one or more voids extending partially through the block.

After compaction, the pallet drops to separate from the mold, thereby discharging the shaped block(s) through the open bottom of the mold by the force of the compression member moving through the mold. The pallet, with formed block(s), then drops from the mold and moves along the automated conveyor to be stacked or collected for transport to another location, such as a kiln, for curing.

To facilitate adding detail to the surfaces compressed by stripper shoes, heating elements are included in the stripper shoes to prevent accumulation of fill material from fouling the stripper shoe and degrading the quality of detail on the molded blocks. U.S. Pat. Nos. 5,249,950; 5,711,129; 5,795,105; and 6,113,318 disclose the use of heated stripper shoes to form details in the body of the molded block. These patents, however, do not teach the use of heated stripper shoes to form detail on the front face of a composite masonry block.

It should be noted that the top of the block in the preceding example is formed by the steel pallet in order to present a finished look to a block placed at the top of a wall and to allow for ease of manipulation, storage and transportation. Intricate block designs are not thought to be well suited to high-speed manufacture.

The block mold can also be configured to manufacture one or more blocks per cycle. Division plates are used within the mold to separate and define adjacent cavities, which allows multiple blocks to be made with each machine cycle.

Insets and protrusions are placed on the top or bottom of blocks to allow these features to be stamped into the blocks by the shoes attached to the compression member of the block machine. These features, when desired, may only be formed on one surface of the blocks because the blocks are removed through the top or bottom of the mold used to form the block in a high-speed operation. Alternatively, features must extend all the way through the block. This arrangement prevents the use of the compression member to form decorative front surfaces for blocks that have insets and protrusions, such as locator lips. Therefore, features on the vertical surfaces of blocks with insets and protrusions made in a high-speed block machines had to be vertically linear in nature with little relief in comparison to the width and depth of the block.

It is a continuing desire to provide blocks that closely resemble the look of natural stone, which is appealing for retaining walls. The retaining block manufacturing industry moved towards manufacturing processes that result in blocks with irregular front surfaces to simulate a natural look. These methods included spraying the front face of an uncured block to wash away some cement to leave exposed aggregate, or “weathering” a cured block by tumbling it in a tumbler with tumbler chips that knock off random pieces of the block, which rounds the edges and creates a look closer to the appearance of a natural stone. Both of these methods are labor intensive and can damage the blocks and results in a higher overall cost of production.

The most common current method of producing a retaining wall block with a front surface that approximates the look of natural stone is to split a cured block during the manufacturing process so that the front surface of the block has a fractured concrete surface that looks somewhat like a natural split rock. This is done by forming a slab in a mold and providing one or more grooves in the slab to function as one or more splitting planes. The slab is then split apart to form two or more blocks. A further attempt to improve the aesthetics of retaining wall blocks included making the front surface of the block with multiple facets as shown in U.S. Pat. No. D380,560. This gave the front face of structures built with these blocks some visual depth to make the structure look more natural. The number of facets and their arrangement (e.g., symmetrical or unsymmetrical) could be varied to provide for different looks such as shown in U.S. Pat. No. D429,006.

More recent patents, such as U.S. Pat. No. 6,321,740, disclose modification of the splitter blade used in splitting the cured block to provide edges that appear more weathered. Splitting, however, adds additional production costs by requiring an additional step to the manufacturing process and because it results in significant waste material. Furthermore, split-faced composite masonry blocks do not sufficiently resemble natural stone to satisfy consumer needs.

Another method to make blocks that more resemble natural stone has been described in U.S. Pat. Nos. 5,078,940; 5,217,630; and 6,224,815. These patents describe a method and an apparatus for manufacturing a concrete block having an irregular surface. The irregular surface can be made to look similar to split stone. This method includes pouring uncured block material into a mold cavity and causing a portion of the material to be retained in place relative to the cavity walls when the block is removed from the cavity. The result is a somewhat split appearance for the surface, without having to perform the splitting operation. However, the block produced from this method still does not satisfactorily resemble natural stone.

Existing methods do not allow for the manufacture of composite masonry blocks with both a locator lip and the precise manufacture of vertical faces that have varying relief because removal of compressed blocks from conventional molds requires smooth vertical surfaces. In light of the conventional processes, there is a continuing need for a method of making a composite masonry block for constructing retaining walls and other landscape structures that produces a block that combines the simplicity of installation found in modem mortarless retaining wall blocks with the appearance of natural stone without the additional manufacturing costs of splitting or tumbling blocks and without generating the significant waste material caused by splitting blocks or retaining a portion of the uncured concrete in the manufacturing mold. Disadvantageous aspects of current methods of block making are addressed by the present invention.

### SUMMARY OF THE INVENTION

A method of making a composite masonry retaining wall block is disclosed for molding a protrusion on one face of the block and a decorative face on another face of the block. The method allows for manufacture of composite masonry retaining wall blocks that have a decorative face.

A mold is provided, which has a plurality of sidewalls, an open top and an open bottom. The plurality of sidewalls may have structure forming a notched portion corresponding to the desired location of the lip. The mold is positioned with respect to a pallet so that the open bottom of the mold temporarily closes during a portion of the manufacturing process. A concrete mixture is introduced to the mold through the open top of the mold and then vibrated. Next, the concrete mix is compacted within the mold by pressing on the mix with a compression head. Shoes may be attached to the compression head to impart a decorative front face on the block. The step of compression also forces the concrete mixture into the notched portion, thereby forming a protrusion that extends from a surface of the block.

### DESCRIPTION OF THE DRAWINGS

FIG. 1 is a perspective view illustrating the composite masonry retaining wall block of the present invention.

FIG. 2 is a side view of the embodiment shown in FIG. 1.

FIG. 3 is a front view of the embodiment shown in FIG. 1.

FIG. 4 is a longitudinal cross-section of a block mold used in a block making machine.

FIGS. 5a-5f show cross-sections of several different embodiments of division plates used in the mold shown in FIG. 4.

FIG. 6 is a longitudinal cross-section of a block mold and a compression member with six stripper shoes attached.

FIG. 7 is a flowchart showing the steps of making composite masonry blocks using a block making machine.

### DETAILED DESCRIPTION OF A PREFERRED EMBODIMENT

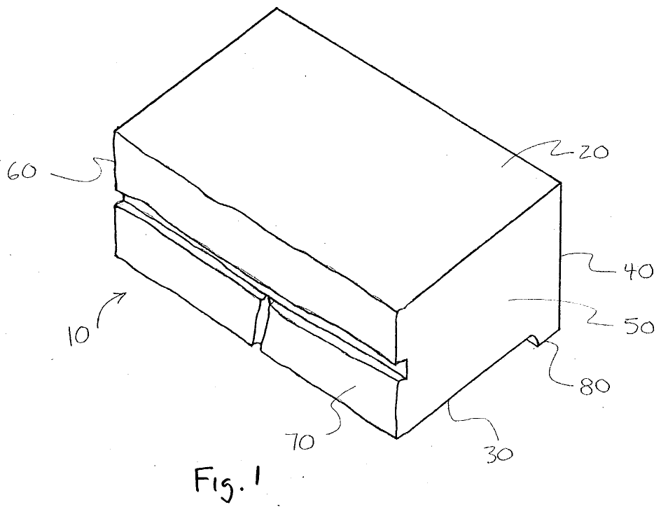

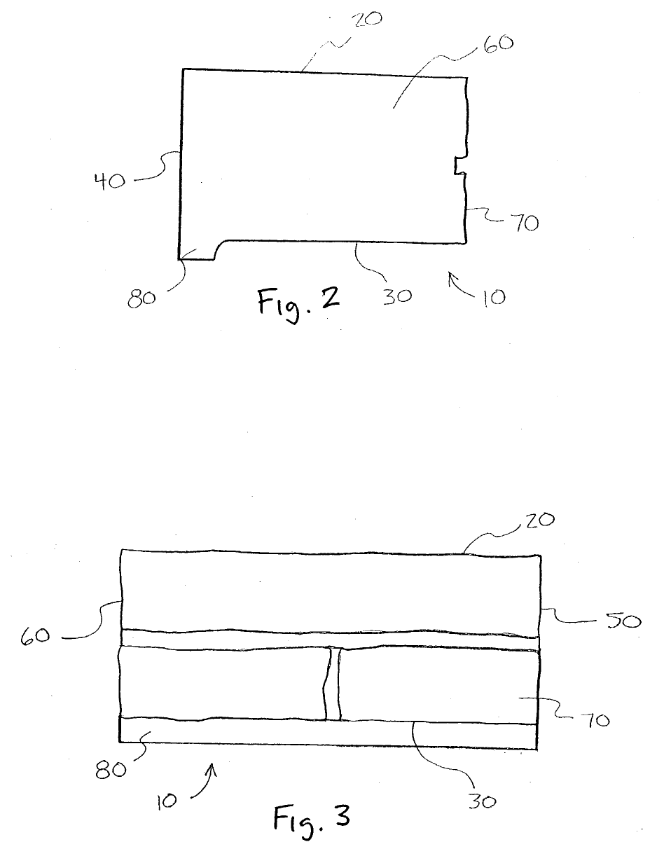

A retaining wall block 10 made by the method of the present invention is shown in FIGS. 1-3. Generally, block 10 will have at least six sides including a top surface 20, a bottom surface 30, a rear surface 40, a first side surface 50, a second side surface 60, and a front surface 70. The dimensions and respective orientations of each surface can be varied to provide for a variety of constructions (i.e., size of wall, curvature of wall, etc.). A protrusion 80 extends from bottom surface 30 of retaining wall block 10. The protrusion shown is in the form of a lip; however, those having skill in the art will recognize that the protrusion may take other forms and be located at other locations on the block without departing from the scope of the present invention.

Protrusion 80 engages the one or more blocks in a lower course of blocks when stacked in a wall. Protrusion 80 may vary in location on block 10 to vary the setback of a given block with respect to adjacent blocks in higher and lower courses within the wall. The protrusion may also be located on the top surface 20 of block 10. The protrusion 80 may also vary in size, shape, and configuration to meet the structural or decorative uses of block 10.

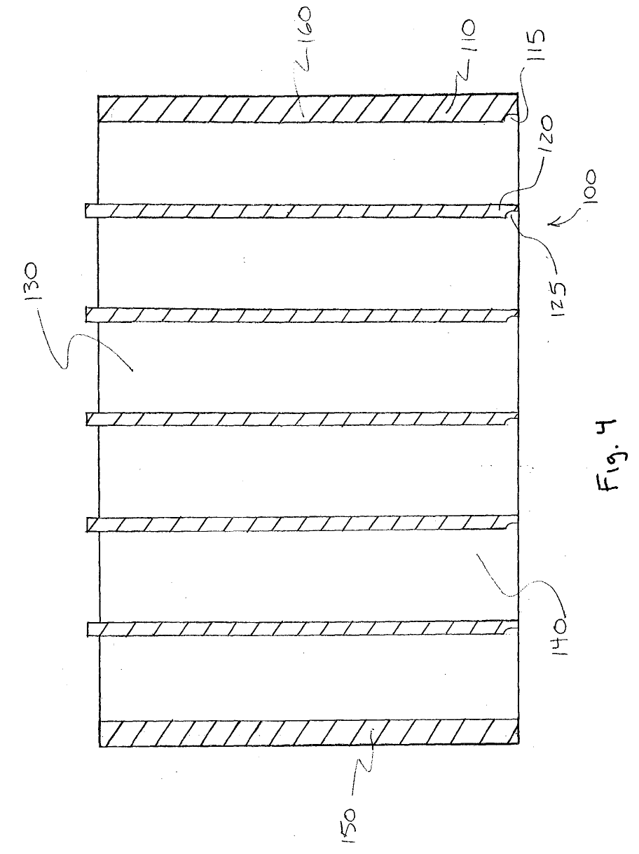

FIG. 4 shows a longitudinal cross-section of a typical block mold 100 used with a block making machine to manufacture the block 10 shown in FIGS. 1-3. Block mold 100 consists of a mold frame 110 and a plurality of divider plates 120, and may contain cores (not shown) to form voids in the block products. Block mold 100 may also be configured to allow the use of core-pullers that make cores or retaining pinholes in the retaining wall block 10. Block mold 100 has an upper portion 130, lower portion 140, first side portion 150, and second side portion 160.

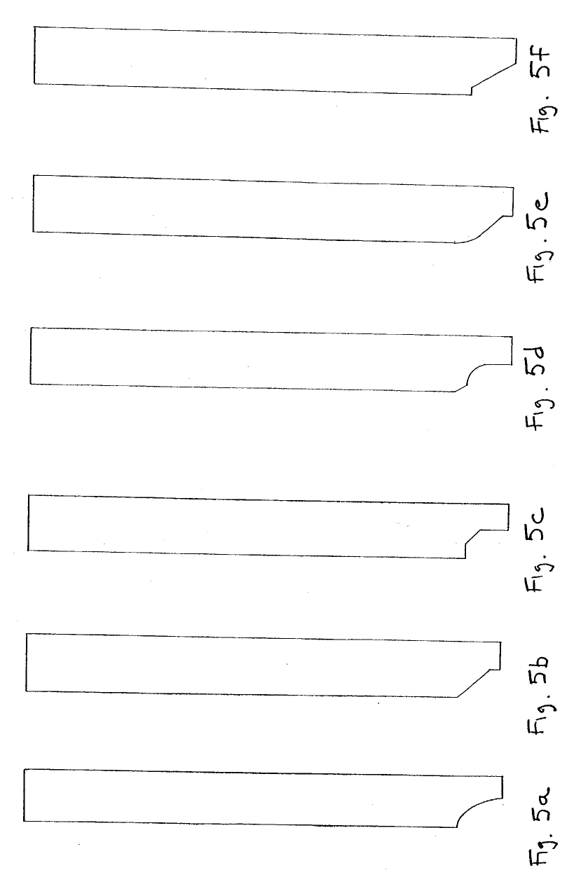

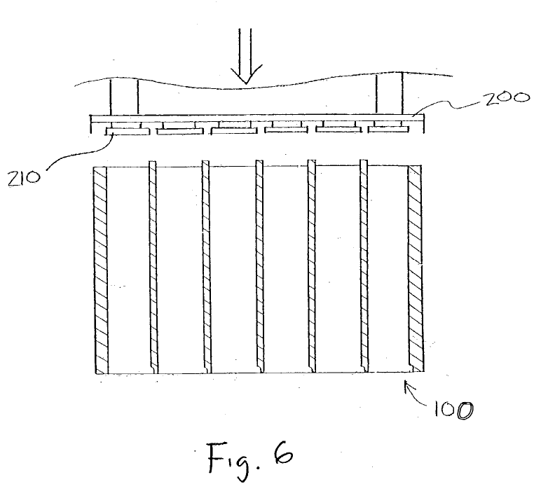

Protrusion 80 of block 10 is formed via a notch 125 in division plate 120. Alternatively, protrusion 80 of block 10 may be formed via notch 115 in mold frame 110. FIGS. 5a-5f show cross-sections of several different embodiments of division plate 120, each having a different configuration for the notch 125. Notch 125 may extend across the entire width of division plate 120 or across one or more distinct portions of the width of division plate 120 to provide a respective protrusion 80 on the block 10. Location of protrusion 80 may be anywhere on the bottom surface 30 of block 10 and may be accomplished by locating notch 125 in different locations in division plate 120. As shown in FIG. 6, the compression member 200 of the block making machine compresses concrete added to block mold 100 to form block 10 having protrusion 80 on bottom surface 30.

In a preferred embodiment of the present invention, block mold 100 is configured so that front surface 70 of block 10 is formed at the upper portion 130 of block mold 100 by compression member 200 of the block making machine and rear surface of block 10 is formed at the lower portion 140 of block mold 100. To provide a detailed appearance to front surface 70 of block 10, at least one stripper shoe 210 that defines the detailed appearance is attached to the compression member 200.

To prevent concrete material from accumulating on stripper shoe 210 and degrading the quality of the predetermined appearance to front surface 70, stripper shoe 210 is heated. Heat is provided to stripper shoe 210 by operatively connecting at least one heat element (not shown) to stripper shoe 210. The heat element may be any of a number of electrical resistance elements that may be hard wired, solid state, or semiconductor circuitry. A preferred embodiment of providing a heated stripper shoe 210 comprises hard wired resistance elements wherein the heat element is bolted to stripper shoe 210. The divider plates 120 are also heated in a preferred embodiment of the present invention to minimize retention of material in the notched portions 115. The mold 100, or portions thereof, may be heated as well. A preferred temperature for heating is between 360 and 400 degrees farenheit. However, it should be recognized that the heating temperature may be greater or less than this range without departing from the scope of the present invention.

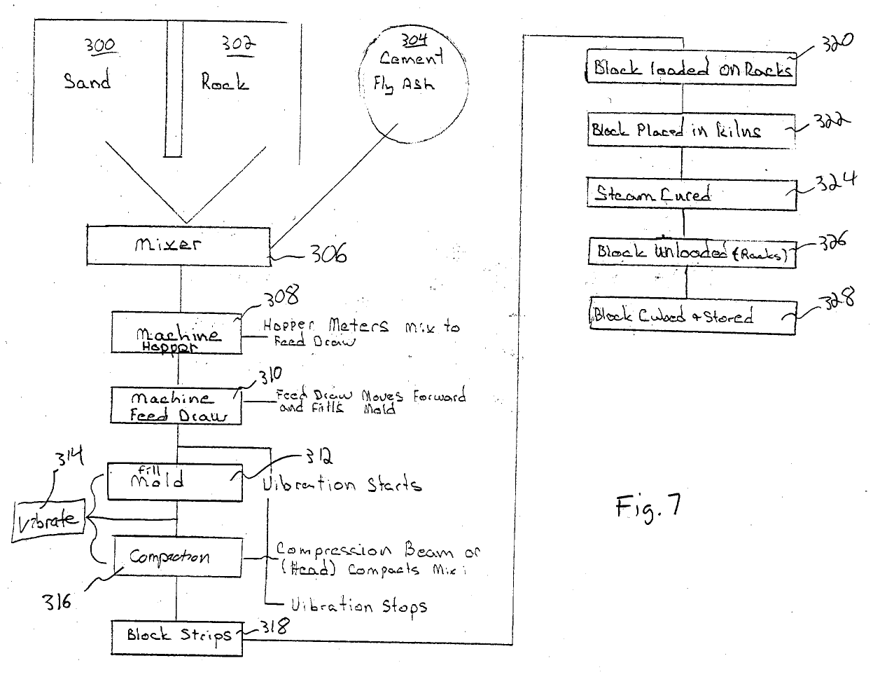

The steps of making block 10 according to a preferred embodiment of the present invention are depicted by the flowchart shown in FIG. 7. Sand 300, rock 302, and cement fly ash 304 are mixed together 306 to form a concrete mixture and transferred to a machine hopper 308.

A batch of a preferred concrete mixture comprises 1535 lbs. rock, 2085 lbs. sand, 110 lbs. fly ash, 400 lbs. cement, 35 oz. Colorscape 120 from ACM Chemistries, Inc., and 10 oz. Procast 200 from ACM Chemistries, Inc. The Procast 200 is an admixture that is commonly referred to as a densifier. The Colorscape 120 is an admixture that controls the efflorescence of the unit. Those having skill in the art will recognize that other substances may be added to this mixture, such as colorants, or substituted for the described elements without departing from the scope of the present invention.

The machine hopper 308 provides concrete mixture to a meter belt, which meters the concrete mixture into a machine feed box or drawer 310, which then feeds the concrete mixture into mold 312. The block machine vibrates the mold 314 as the concrete mixture is fed into the mold, and during compaction 316 of the concrete by the compression member 200 of the block machine. The compression head compacts 316 the mixture in the mold 100 in a compression direction. The movement of the compression head causes the shoe, which is fastened to the head, to mold the face detail on the block. The compaction operation 316 also urges the mixture into the notches 115 to form the protrusion on the block. After compaction 316, the vibration 314 is halted and the uncured blocks are stripped 318 from block mold 100. The uncured blocks are then loaded on racks 320, which are then conveyed to a curing location, such as a kiln 322 where the curing process takes place. A preferred curing process is known as steam curing 324. Once cured, the finished blocks are unloaded from the racks 326 and stacked in cubes 328 for storage or transport. Those having skill in the art will recognize that variations in the above-described process may be performed for the described steps without departing from the scope of the present invention.

As many different embodiments of the present invention can be made without departing from the spirit and scope thereof, it is to be understood that the invention is not limited to the specific embodiments thereof except as defined in the following claims.

1. A method of manufacturing an uncured composite masonry block, the method comprising the steps of:
providing a mold, the mold having a plurality of sidewalls, a first opening and an opposed second opening;
providing a pallet;
positioning the mold and pallet so that the second opening of the mold temporarily closes during a portion of the manufacturing process;
creating a concrete mixture;
adding a densifier to the concrete mixture;
introducing the concrete mixture to the mold through the first opening;
vibrating the concrete mixture within the mold;
compacting the concrete mixture within the mold by pressing on the mix with a compression head to impart a decorative face on the block corresponding to a shoe provided to the compression head; and
releasing the block from the mold by moving the pallet relative to the mold.

2. The method of claim 1, further comprising the step of providing one or more divider plates to the mold.

3. The method of claim 2, further comprising the step of notching the one or more divider plates.

4. The method of claim 2, further comprising the step of heating at least a portion of the one or more divider plates.

5. (Cancelled)

6. The method of claim 1, further comprising the step of heating the shoe.

7. The method of claim 1, further comprising the step of heating at least a portion of the mold.

8. A method of manufacturing an uncured composite masonry block, the method comprising the steps of:
providing a mold, the mold having a plurality of sidewalls, a first opening and an opposed second opening;
providing a pallet;
providing at least one divider plate within the mold;
heating at least a portion of the one or more divider plates;
positioning the mold and pallet so that the second opening of the mold temporarily closes during a portion of the manufacturing process;
introducing a concrete mixture to the mold through the first opening;
vibrating the concrete mixture within the mold;
compacting the concrete mixture within the mold by pressing on the concrete mixture with at least one shoe attached to a compression head to impart a decorative face on the block;
releasing the block from the mold by moving the pallet relative to the mold; and placing the uncured block in a curing apparatus.

9. (Cancelled)

10. The method of claim 8, further comprising the step of notching the at least one divider plate.

11. (Cancelled)

12. The method of claim 8, further comprising the step of heating the at least one shoe.

13. The method of claim 8, further comprising the step of heating at least a portion of the mold.

14-19. (Cancelled)

20. A method of manufacturing an uncured composite masonry block using a block making machine having at least one compression member and a block mold, the method of manufacturing comprising:
providing at least one divider plate placed inside of the block mold;
heating the at least one divider plate;
stripping the uncured block from the mold; and
placing the uncured block in a curing apparatus.

21. (Cancelled)

22. The method of claim 20, further comprising the step of removing material from the at least one divider plate to define a notch.

23. The method of claim 20, further comprising the step of fastening at least one stripper shoe to the at least one compression member.

24. The method of claim 23, further comprising the step of heating the at least one stripper shoe.

25-35. (Cancelled)

36. The method of claim 1, further comprising the step of adding an efflorescence control admixture to the concrete mixture.

37. The method of claim 8, further comprising the step of transporting the uncured composite masonry block to a curing location.

38. A method of manufacturing an uncured composite masonry block, the method comprising the steps of:
providing a mold, the mold having a plurality of sidewalls, a first opening and an opposed second opening;
providing a pallet;
positioning the mold and pallet so that the second opening of the mold temporarily closes during a portion of the manufacturing process;
introducing a concrete mixture to the mold;
vibrating the concrete mixture within the mold;
heating at least a portion of the mold;
compacting the concrete mixture within the mold by pressing on the mix with a compression head to impart a decorative face on the block; and
releasing the block from the mold by moving the pallet relative to the mold.

39. A method of manufacturing a composite masonry block, the method comprising the steps of:
introducing a mixture including sand, rock, cement, fly ash and a densifier into a mixer;
providing the mixture to a hopper;
providing a mold, the mold having a plurality of sidewalls, a first opening and an opposed second opening;
introducing the mixture to the mold through the first opening;
positioning a pallet relative to the second opening of the mold so that the second opening temporarily closes during a portion of the manufacturing process;
compacting the concrete mixture within the mold to impart a decorative face on the block; and
releasing the block from the mold by moving the pallet relative to the mold.

40. The method of claim 39, further comprising the step of vibrating the concrete mixture within the mold.

41. The method of claim 39, further comprising the step of heating at least a portion of the mold.

42. The method of claim 39, further comprising the step of providing one or more divider plates to the mold.

43. The method of claim 42, further comprising the step of notching the one or more divider plates.

44. The method of claim 42, further comprising the step of heating at least a portion of the one or more divider plates.

45. The method of claim 39, further comprising the step of pressing a stripping shoe into the concrete mixture in order to impart a decorative face on the block corresponding to the shoe.

46. A method of manufacturing an uncured composite masonry block, the method comprising the steps of:
providing a mold;
providing at least one divider plate to the mold;
heating a portion of the mold and a portion of the at least one divider plate;
introducing a concrete mixture to the mold;
compacting the concrete mixture within the mold;
stripping the uncured block from the mold; and
transporting the uncured block to a curing location.

47. A method of manufacturing an uncured composite masonry block, the method comprising the steps of:
creating a concrete mixture;
adding a densifier to the concrete mixture;
introducing the concrete mixture to a mold;
compacting the concrete mixture within the mold to impart a decorative face on the block corresponding to a shoe provided to a compression head; and
stripping the uncured block from the mold.

48. The method of claim 47, further comprising the step of adding an efflorescence control admixture to the concrete mixture.
